(19) United States
(12) Patent Application Publication
(10) Pub. No.: US 2007/0262778 A1
(43) Pub. Date: Nov. 15, 2007

(54) DC TEST APPARATUS

(75) Inventors: Hiroki Ando, Tokyo (JP); Hironori Tanaka, Tokyo (JP)

Correspondence Address: PATENTTM.US, P. O. BOX 82788, PORTLAND, OR, 97282-0788, US

(73) Assignee: ADVANTEST CORPORATION, Tokyo (JP)

(21) Appl. No.: 11/746,584

(22) Filed: May 9, 2007

(30) Foreign Application Priority Data
May 12, 2006 (JP) 2006-133480

(51) Int. Cl. G01N 27/42

(52) U.S. Cl. 324/425

(57) ABSTRACT

An object of the present invention is to provide a DC test apparatus capable of reducing wasteful standby power consumption. The DC test apparatus has a power amplifier circuit 130 for supplying a current to a DUT during a test. The power amplifier circuit 130 is provided with transistors 18 and 20 for generating an output current appropriate for an input voltage during current supply, resistors 54 and 56, and a variable resistance circuit 40 for setting a standby current flowing through these transistors 18 and 20 and the like during current supply to a smaller value at any time other than during current supply.

### BACKGROUND OF THE INVENTION

1. Field of the Invention

The present invention relates to a DC test apparatus for performing force voltage/measure current type measurements and force current/measure voltage type measurements on a DUT (electronic device as a device under test).

2. Description of the Related Art

As tests performed on a DUT, such as a semiconductor device, there are conventionally known a force voltage/measure current mode test wherein a predetermined DC voltage is applied and DC currents flowing through DUT pins at the time are measured and a force current/measure voltage mode test wherein a predetermined DC current is applied and DC voltages developing at DUT pins at the time are measured (refer to, for example, Japanese Patent Laid-Open No. 2005-315729). The DC test apparatus is intended to perform these tests and is often inherent in semiconductor test apparatus as part of the functions thereof.

Incidentally, the above-described DC test apparatus has had the problem that a standby current must be flowed through a current generating section even in a standby state wherein no currents and voltages are applied (supplied), thus consuming wasteful power. In addition, the DC test apparatus is provided with a plurality of current generating sections according to the number of DUT pins or the number of simultaneously measurable DUTs. Hence, if the amount of power consumed at each current generating section increases, there also increases the scale of a cooling mechanism for suppressing a temperature rise in the apparatus as a whole due to heat generated by these current generating sections. It is therefore preferable that the amount of heat generated at each current generating section be reduced.

### SUMMARY OF THE INVENTION

The present invention has been accomplished in view of the above-described problems. It is therefore an object of the present invention to provide a DC test apparatus capable of reducing wasteful standby power consumption.

The DC test apparatus of the present invention has a power amplifier circuit for supplying a current to an electronic device during the testing thereof. The power amplifier circuit is provided with an output current generating unit for generating an output current to be supplied to an electronic device and a standby current switching unit for setting a standby current flowing through the output current generating unit to a smaller value at any time other than during current supply. Accordingly, it is possible to reduce the standby current of the power amplifier circuit provided for current supply at any time other than during current supply. Consequently, it is possible to reduce power consumption of the power amplifier circuit and thereby downscale a cooling mechanism.

It is also preferable that a standby current set except during current supply be larger than the minimum value thereof whereby stable operation can be guaranteed. Accordingly, it is possible to prevent the power amplifier circuit from going into unstable operation when shifting to current supply operation.

Furthermore, it is preferable that the above-described power amplifier circuit be provided with an input stage circuit formed of a current mirror circuit. In addition, the standby current switching unit should preferably be included in the current mirror circuit and be a variable resistance circuit for varying a current flowing between positive and negative power lines. Alternatively, it is preferable that the above-described standby current switching unit be included in the output current generating unit and be a variable resistance circuit for varying a current flowing between positive and negative power lines. It is also preferable that the DC test apparatus is further provided with a power supply circuit for generating supply voltages to be respectively applied to the above-described positive and negative power lines whereto the above-described power amplifier circuit is connected. In addition, the standby current switching unit should preferably be a unit for varying the supply voltages to be applied from the power supply circuit to the power lines. It is particularly preferable that the above-described power supply circuit be capable of generating supply voltages having a plurality of voltage values and that the above-described standby current switching unit be a switch for selecting one of the supply voltages having a plurality of voltage values. Consequently, it is possible to certainly reduce a standby current flowing through an output stage (output current generating unit) except during current supply.

### BRIEF DESCRIPTION OF THE DRAWINGS

FIG. 1 is a schematic view illustrating the overall configuration of a DC test apparatus in accordance with one embodiment of the present invention;

FIG. 2 is a schematic view illustrating the detailed configuration of a power amplifier circuit;

FIG. 3 is a schematic view illustrating a specific example of a variable resistance circuit;

FIG. 4 is a schematic view illustrating an example of modification of the variable resistance circuit;

FIG. 5 is a schematic view illustrating an example of modification of a power amplifier circuit for reducing a current “Id” except during current supply;

FIG. 6 is a schematic view illustrating another example of modification of a power amplifier circuit for reducing a current “Id” except during current supply; and

FIG. 7 is a schematic view illustrating still another example of modification of a power amplifier circuit for reducing a current “Id” except during current supply.

### DETAILED DESCRIPTION OF THE PREFERRED EMBODIMENTS

A DC test apparatus of one embodiment to which the present invention is applied will hereinafter be described in detail with reference to the accompanying drawings. FIG. 1 is a schematic view illustrating the overall configuration of a DC test apparatus in accordance with one embodiment of the present invention. As illustrated in FIG. 1, a DC test apparatus 100 of the present embodiment is provided with resistors 110, 112 and 114, differential amplifier circuits 120 and 140, a power amplifier circuit 130, and switches 150 and 152. The DC test apparatus is provided in a semiconductor test apparatus, for an example. The DC test apparatus 100 is connected to one of the pins of a DUT 300 and applies (supplies) a DC voltage or current to this pin. In addition, a DC power supply 200 the voltage value “Vin” of which is alterable and an analog-to-digital converter (ADC) 210 for converting an analog voltage to digital data (voltage data) are connected to the DC test apparatus 100. The DC power supply 200 is configured with, for an example, a digital-to-analog converter, wherein an analog voltage appropriate for data input from an unillustrated control apparatus (for an example, a tester processor for controlling overall test operation in the semiconductor test apparatus provided with the DC test apparatus) is output from the digital-to-analog converter.

The DC power supply 200 is connected through the resistor 110 to the inverting input terminal of the differential amplifier circuit 120, and the non-inverting input terminal the differential amplifier circuit 120 is grounded. The output terminal of the differential amplifier circuit 120 is connected to the input terminal of the power amplifier circuit 130. The output terminal of the power amplifier circuit 130 is connected through the resistor 114 to the pins of the DUT 300 to which a voltage/current is applied (supplied). The differential amplifier circuit 140 amplifies a voltage developing across the resistor 114.

One switch 150 switches the state of connection of a contact “c” with a contact “a” and with a contact “b”. In a state wherein the contacts “c” and “a” of the switch 150 are connected to each other, one end of the resistor 110 is connected to the DUT 300 through the resistor 112. In a state wherein the contacts “c” and “b” of the switch 150 are connected to each other, one end of the resistor 110 is connected to the output terminal of the differential amplifier circuit 140 through the resistor 112.

Similarly, the other switch 152 switches the state of connection of a contact “c” with a contact “a” and with a contact “b”. In a state wherein the contacts “c” and “a” of the switch 152 are connected to each other, the output terminal of the differential amplifier circuit 140 is connected to the analog-to-digital converter 210. In a state wherein the contacts “c” and “b” of the switch 152 are connected to each other, the connection point of the resistor 114 and the DUT 300 is connected to the analog-to-digital converter 210.

When performing a force voltage/measure current mode test, both switches 150 and 152 are switched to the contact “a” side. In other words, the DC power supply 200 is connected to the DUT 300 through the two resistors 110 and 112 and the output terminal of the differential amplifier circuit 140 is connected to the analog-to-digital converter 210. Assuming that the resistance value of the resistor 110 is “Ri”, the resistance value of the resistor 112 is “Rf” and the output voltage of the DC test apparatus 100 to be applied to the DUT 300 is “Vo”, then the following relational expression holds true among them:
Vo=−(Rf/Ri)×Vin. (1)

Now assume that the resistance value of the resistor 114 is “Rm”, the gain of the differential amplifier circuit 140 is “G3”, and the output voltage of the differential amplifier circuit 140 is “Vad”, then a current “Io” supplied from the DC test apparatus 100 to the DUT 300 is
Io=Vad/(G3×Rm). (2)
Thus, there is performed the measurement of the current “Io” flowing through the pin to which the voltage “Vo” is applied.

When performing a force current/measure voltage mode test, both switches 150 and 152 are switched to the contact “b” side. In other words, the output terminal of the differential amplifier circuit 140 is connected to one end of the resistor 112 and the connection point of the DC test apparatus 100 and the DUT 300 is connected to the analog-to-digital converter 210. In this state of connection, the current “Io” supplied from the DC test apparatus 100 to the DUT 300 can be represented by the following relational expression:
Io=−(Rf/Ri)×Vin×(1/G3)×(1/Rm). (3)
The voltage “Vo” to be applied to the DUT 300, which is at this point directly applied to the analog-to-digital converter 210, is converted to voltage data and measured.

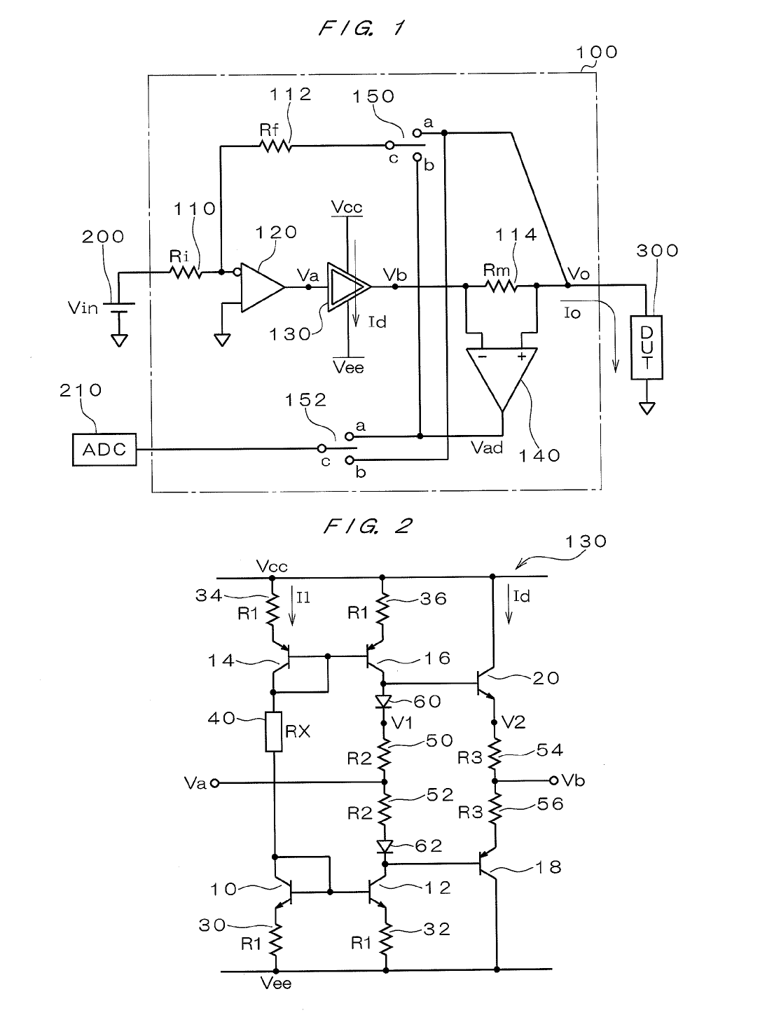

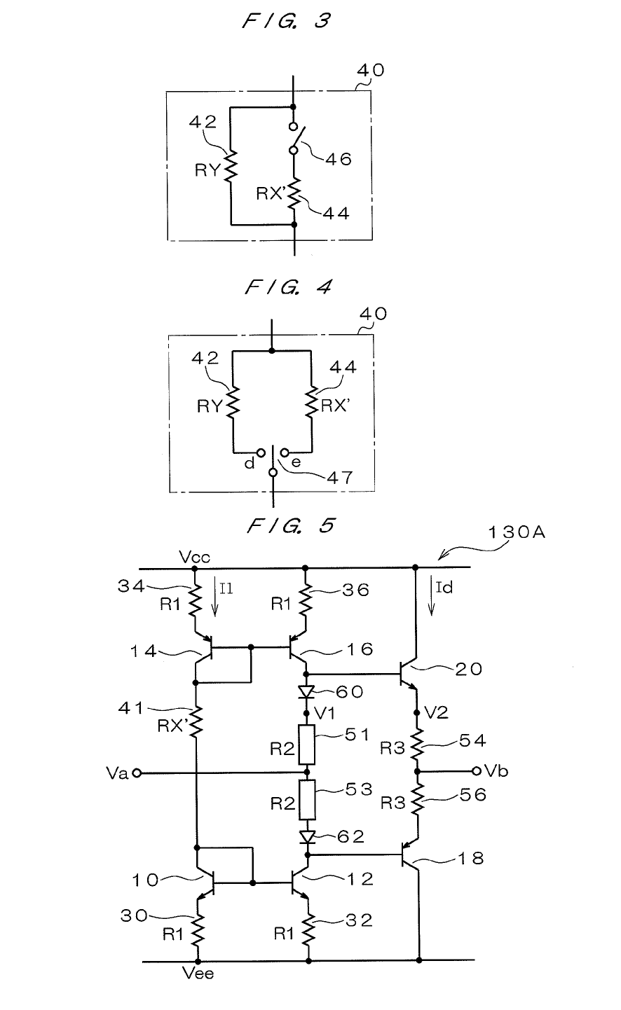

FIG. 2 is a schematic view illustrating the detailed configuration of a power amplifier circuit 130. As illustrated in FIG. 2, the power amplifier circuit 130 is configured by including transistors 10, 12, 14, 16, 18 and 20, resistors 30, 32, 34, 36, 50, 52, 54 and 56, a variable resistance circuit 40, and diodes 60 and 62. The transistors 18 and 20 and the resistors 54 and 56 correspond to an output current generating unit. The variable resistance circuit 40 corresponds to a standby current switching unit. The rest of the configuration excluding the transistors 18 and 20 and the resistors 54 and 56 corresponds to an input stage circuit.

Current mirror circuits are respectively formed of the transistors 10 and 12 and of the transistors 14 and 16. Assuming that the base-emitter voltage of the transistors 10, 14 and the like is “VBE” and the forward voltage of the diodes 60 and 62 is “VF”, then a current “I1” flowing through a series circuit composed of the resistor 34, the transistor 14, the variable resistance circuit 40, the transistor 10 and the resistor 30 is
I1=(Vcc−Vee−2×VBE)/(2×R1+RX), (4)
where “Vcc” denotes a supply voltage to be applied to the positive power line, “Vee” denotes a supply voltage to be applied to the negative power line, “R1” denotes the resistance value of the resistors 30, 32, 34 and 36, and “RX” denotes the resistance value of the variable resistance circuit 40.

Now, assuming that the input voltage “Va”=0, a voltage “V1” developing at the connection point of the diode 60 and the resistor 50 is
V1=I1×R2. (5)
Assuming further that VBE=VF, then
V2=V1, (6)
where “V2” denotes a voltage developing at the connection point of the transistor 20 and the resistor 54. Since the power amplifier circuit 130 illustrated in FIG. 2 has a push-pull circuit configuration, the voltage “V2” is given by
V2=Id×R3, (7)
where “Id” denotes a current (standby current) flowing through a series circuit composed of the transistor 20, the resistors 54 and 56, and the transistor 18, and “R3” denotes the resistance value of the resistors 54 and 56.

The current “Id” is determined as follows from Expression (4) using Expression (7):
Id=((Vcc−Vee−2×VBE)/(2×R1+RX))×R2/R3. (8)
Now assuming that RX>>R1, then
Id=((Vcc−Vee−2×VBE)/RX))×R2/R3. (9)
According to Expression (9), it is understood that the current “Id” is determined by the positive and negative supply voltages “Vcc” and “Vee”, the base-emitter voltage “VBE” of the transistor 20 and the like, the resistance value “RX” of the variable resistance circuit 40, and the resistance ratio “R2/R3” of the resistors 50 and 52 to the resistors 54 and 56.

Incidentally, factors (1) and (2) mentioned below are required in designing the power amplifier circuit 130.
(1) Fast response
(2) Load stability
   For fast response, it is preferable that switching distortion characteristics of a transistor be excellent and, therefore, the active region operation of transistors is essential. For load stability, it is preferable that the power amplifier circuit 130 has stability unsusceptible to a load connected and, more specifically, the output impedance of the power amplifier circuit 130 be kept constant.

For the above-described reasons, the design objective is that the operating points of transistors do not change largely when the output current “Io” varies between 0 (A) and its maximum value. From such a point of view as described above, “Id” has traditionally been set to approximately 20% of the output current “Io”.

In contrast, in the power amplifier circuit 130 of the present embodiment, although the value of “Id” is set in a similar manner (for example, to 20% of the output current “Io”) in an operating state wherein a current necessary for measurement is being supplied, it is reduced in a standby state other than during current supply.

As described above, it can be understood from Expression (9) that “Id” is determined by the positive and negative supply voltages “Vcc” and “Vee”, the base-emitter voltage “VBE” of the transistor 20 and the like, the resistance value “RX” of the variable resistance circuit 40, and the resistance ratio “R2/R3” of the resistors 50 and 52 to the resistors 54 and 56. In the power amplifier circuit 130 of the present embodiment, the variable resistance circuit 40 is used and, therefore, the resistance value RX thereof is variable. The resistance value “RX” is increased at any time other than during current supply in order to reduce “Id”.

FIG. 3 is a schematic view illustrating a specific example of the variable resistance circuit 40. The variable resistance circuit 40 illustrated in FIG. 3 is provided with two resistors 42 and 44 and a switch 46. When the switch 46 is turned off, the variable resistance circuit 40 is formed only of the resistor 42, whereas it is formed of a parallel circuit composed of the resistors 42 and 44 when the switch 46 is turned on.

At the time of current supply, the switch 46 is turned on. Since a parallel circuit based on the resistors 42 and 44 is formed at this point, the resistance value of the variable resistance circuit 40 decreases. Assuming that the resistance value of the resistor 42 is “RY” and the resistance value of the resistor 44 is “RX′”, the resistance value “RX” of the variable resistance circuit 40 when the switch 46 is turned on is
RX=RX′×RY/(RX′+RY). (10)
Now assuming that the resistance value “RX′” is expressed as “RX′”<<“RY”, the resistance value “RX” of the variable resistance circuit 40 is substantially equal to the resistance value “RX′” of one resistor 44.

The switch 46 is turned off except during current supply. At this point, the variable resistance circuit 40 is formed only of the resistor 42. In other words, the resistance value “RX” of the variable resistance circuit 40 is equal to the resistance value “RY” of the other resistor 42.

In this way, the switch 46 is turned on during current supply and the resistance value “RX” of the variable resistance circuit 40 is set so as to be substantially equal to the lower resistance value “RX′” of one resistor 44. Consequently, it is possible to generate an amount of current “Id” necessary during current supply. On the other hand, the switch 46 is turned off except during current supply and the resistance value. “RX” of the variable resistance circuit 40 is set so as to be substantially equal to the higher resistance value “RY” (>>“RX′”) of the other resistor 42. The current “Id” can thus be reduced. Accordingly, it is possible to reduce wasteful standby power consumption by the power amplifier circuit 130. As a result, it is also possible to downscale a cooling mechanism.

Incidentally, the resistance value “RY” of the other resistor 42 is determined to the extent that “Id” is no smaller than its minimum value whereby the stable operation of the transistors 18 and 20 can be guaranteed. Accordingly, it is possible to prevent the power amplifier circuit 130 from going into unstable operation when shifting to current supply operation from the standby state.

FIG. 4 is a schematic view illustrating an example of modification of the variable resistance circuit 40. The variable resistance circuit 40 illustrated in FIG. 4 is configured in such a manner that either a resistor 42 or a resistor 44 is selected by switching a switch 47. The switch 47 is switched to the contact “e” side during current supply and only the resistor 44 having a resistance value “RX′” is selected. Consequently, the resistance value “RX” of the variable resistance circuit 40 decreases. On the other hand, the switch 47 is switched to the contact “d” side except during current supply and only the resistor 42 having a resistance value “RY” is selected. Consequently, the resistance value “RX” of the variable resistance circuit 40 increases.

Incidentally, as described above, the current “Id” given by Expression (9) is determined by the positive and negative supply voltages “Vcc” and “Vee”, the base-emitter voltage “VBE” of the transistor 20 and the like, the resistance value “RX” of the variable resistance circuit 40, and the resistance ratio “R2/R3” of the resistors 50 and 52 to the resistors 54 and 56. Accordingly, it is possible to change the value of the current “Id” by varying the resistance ratio “R2/R3” or the positive and negative supply voltages “Vcc” and “Vee”, in addition to varying the resistance value “RX” of the variable resistance circuit 40.

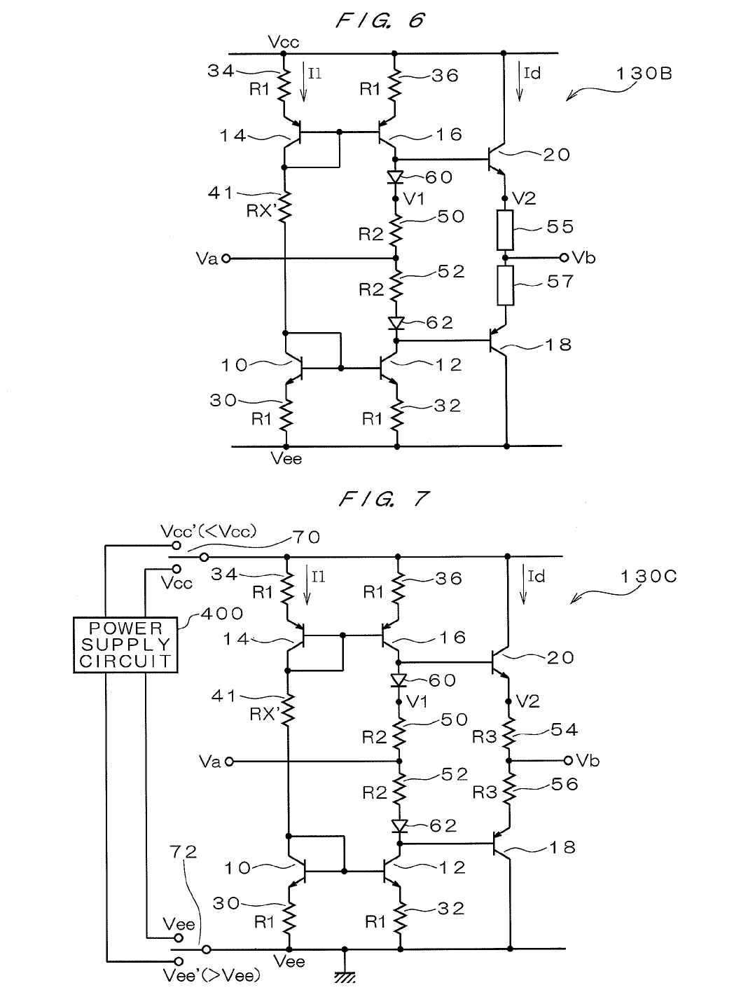

FIG. 5 is a schematic view illustrating an example of modification of a power amplifier circuit for reducing a current “Id” except during current supply. A power amplifier circuit 130A illustrated in FIG. 5 has a configuration different from that of the power amplifier circuit 130 illustrated in FIG. 2 in that the variable resistance circuit 40 is replaced with a resistor 41 having a fixed resistance value “RX′” and the resistors 50 and 52 are replaced with variable resistance circuits 51 and 53 the resistance values of which are variable. The variable resistance circuits 51 and 53 are intended to vary the resistance ratio “R2/R3” in Expression (9). The variable resistance circuits 51 and 53 are used so that the resistance value “R2” thereof is set to a larger value during current supply and set to a smaller value except during current supply (note that a magnitude correlation between resistance values during a period of current supply and a period of no current supply is reversed as viewed from the variable resistance circuit 40 illustrated in FIG. 3 or 4). Accordingly, it is possible to reduce the current “Id” at any time other than during current supply.

FIG. 6 is a schematic view illustrating another example of modification of a power amplifier circuit for reducing a current “Id” except during current supply. A power amplifier circuit 130B illustrated in FIG. 6 has a configuration different from that of the power amplifier circuit 130 illustrated in FIG. 2 in that the variable resistance circuit 40 is replaced with a resistor 41 having a fixed resistance value “RX′” and the resistors 54 and 56 are replaced with variable resistance circuits 55 and 57 the resistance values of which are variable. The variable resistance circuits 55 and 57 are intended to vary the resistance ratio “R2/R3” in Expression (9). The variable resistance circuits 55 and 57 are used so that the resistance value “R3” thereof is set to a smaller value during current supply and set to a larger value except during current supply (note that a magnitude correlation between resistance values during a period of current supply and a period of no current supply is the same as viewed from the variable resistance circuit 40 illustrated in FIG. 3 or 4). Accordingly, it is possible to reduce the current “Id” at any time other than during current supply.

FIG. 7 is a schematic view illustrating still another example of modification of a power amplifier circuit for reducing a current “Id” except during current supply. A power amplifier circuit 130C illustrated in FIG. 7 has a configuration different from that of the power amplifier circuit 130 illustrated in FIG. 2 in that the variable resistance circuit 40 is replaced with a resistor 41 having a fixed resistance value “RX′” and switches 70 and 72 for varying a supply voltage to be applied to positive and negative power lines are added. In addition, a power supply circuit 400 generates two types of positive supply voltages “Vcc” and “Vcc′” (<“Vcc”) and two types of negative supply voltages “Vee” and “Vee′” (>Vee). The power supply circuit 400 may be provided within the power amplifier circuit 130C or otherwise may be provided external thereto. The switches 70 and 72 are intended to vary “Vcc−Vee” in Expression (9). By switching the switches 70 and 72, it is possible to reduce the supply voltage difference “Vcc′−Vee′” applied except during current supply against the supply voltage difference “Vcc−Vee” applied during current supply. Consequently, it is possible to reduce the current “Id” at any time other than during current supply.

What is claimed is:

1. A DC test apparatus having a power amplifier circuit for supplying a current to an electronic device during the testing thereof, wherein said power amplifier circuit comprises:
an output current generating unit for generating an output current to be supplied to said electronic device; and
a standby current switching unit for setting a standby current flowing through said output current generating unit to a smaller value at any time other than during current supply.

2. The DC test apparatus according to claim 1, wherein a standby current set except during current supply is larger than the minimum value thereof whereby stable operation can be guaranteed.

3. The DC test apparatus according to claim 1, wherein said power amplifier circuit is provided with an input stage circuit formed of current mirror circuits and said standby current switching unit is included in said current mirror circuits and is a variable resistance circuit for varying a current flowing between positive and negative power lines.

4. The DC test apparatus according to claim 1, wherein said standby current switching unit is included in said output current generating unit and is a variable resistance circuit for varying a current flowing between positive and negative power lines.

5. The DC test apparatus according to claim 1, further comprising a power supply circuit for generating supply voltages to be respectively applied to positive and negative power lines whereto said power amplifier circuit is connected and said standby current switching unit is a unit for varying supply voltages to be applied from said power supply circuit to said power lines.

6. The DC test apparatus according to claim 5, wherein said power supply circuit is capable of generating supply voltages having a plurality of voltage values and said standby current switching unit is a switch for selecting one of said supply voltages having a plurality of voltage values.

7. A semiconductor test apparatus comprising the DC test apparatus according to claim 1.
